(19) United States
(12) Patent Application Publication
(10) Pub. No.: US 2026/0272093 A1
(43) Pub. Date: Sep. 17, 2026

(54) Cap with components for wearing a mask

(71) Applicant: CHOIR INNOVATION & DEVELOPMENT INC., Coquitlam (CA)

(72) Inventor: Cheng Zhang, Coquitlam (CA)

(73) Assignee: CHOIR INNOVATION & DEVELOPMENT INC., Coquitlam (CA)

(21) Appl. No.: 19/004,342

(22) Filed: Dec. 29, 2024

Related U.S. Application Data
(60) Provisional application No. 63/616,392, filed on Dec. 29, 2023.

(51) Int. Cl. A42B 1/24; A42B 1/02; A62B 18/08

(52) U.S. Cl. CPC A42B 1/24; A42B 1/02; A62B 18/084

(57) ABSTRACT

A cap with components for wearing a mask. The cap comprises a cap body, two mounting base plates, and two arch-shaped components. The two mounting base plates may be respectively fixed on the left and right sides of the cap body. Each of the two arch-shaped components has an integral grooved structure, and can be respectively mounted on the related mounting base plate on the right and left sides of the cap body. The left and right arch-shaped components are respectively located behind the ears of the cap wearer. The two ear-loop straps of a mask are placed in the grooved structures of the two arch-shaped components respectively. In that way, the cap eliminates the burden and discomfort brought to the ears when the ear-loop straps of the mask are directly placed on the ears, and the protective effect of the mask is improved.

### CROSS-REFERENCE TO RELATED APPLICATION

This application claims the benefit of provisional patent application Ser. No. 63/616,392, filed on Dec. 29, 2023, by the present inventor, which is incorporated by reference in its entirety.

### FIELD

The present invention relates to the technical fields of daily necessities and medical protection equipment, in particular to a cap with components for wearing a mask.

### BACKGROUND AND PRIOR ART

Wearing a mask is a common behavior for preventing diseases and maintaining hygiene. In recent years, it has become one of the most effective protective means for preventing related diseases. The traditional practice of wearing the ear-loop straps of a mask directly on the ears has obvious drawbacks: keeping the ear-loop straps of the mask placed on the ears for a long time will bring continuous burden to the ears, causing discomfort and even injuries, especially for the ears of young children who are in growth and development, which is to say, keeping the ear-loop straps of the mask placed on the ears for a long time may easily result in forward-leaning deformation of the ear cartilages of young children, which may lead to a phenomenon of “protruding ears”. Some staff members with particular occupations, such as medical staff, military and police personnel, etc., need to wear a cap for a long time, and often at the same time, need to wear a mask for a long time. For the people who wear a cap, a cap assisting in wearing a mask is a reasonable need.

A previous practice of assisting in wearing a mask by means of a cap is to mount button-type accessories on the two sides of the cap near the ears to hook the ear-loop straps of the mask. Although that practice eliminates the burden on the ears caused by placing the ear-loop straps of the mask directly on the ears, the upper and lower sections of the ear-loop straps of the mask get close to each other at a small included angle during use and can't be routed around the upper and lower ends of the ears and extend to the buttons at the rear side without rubbing the ear when the button-type accessories are mounted on the sides of the cap behind the ears. Consequently, the ear-loop straps of the mask either rub the upper and lower ends of the auricles or press on the front sides of the auricles; as a result, the ear-loop straps of the mask contact with the ears with pressure for a long time. Although the ear-loop straps of the mask don't rub the ears when the button-type accessories are mounted on the sides of the cap above the ears, the upper and lower sections of the ear-loop straps of the mask on each side get close to each other at a small included angle and are pulled in an mainly upward direction instead of a backward direction. Consequently, the improper angles of the ear-loop straps of the mask result in wrinkles and gaps at the upper edge and the two side edges of the mask, and the mask can't wrap the nose and mouth tightly; as a result, the mask can't attain its due protective effect.

### OBJECTS

An object of the present invention is to provide a cap with components for wearing a mask, so as to eliminate the burden and discomfort caused by directly placing ear-loop straps of the mask on the ears, and improve the protective effect of the mask and the convenience in use.

### SUMMARY AND ADVANTAGES OF THE INVENTION

A cap with components for wearing a mask, comprising a cap body, two mounting base plates with snap buttons, and two arch-shaped components with grooved structures and snap holes. The two mounting base plates may be respectively fixed on the left and right sides of the cap body. Each of the arch-shaped components can be mounted on the related mounting base plate by fitting the snap buttons on the mounting base plate into the snap holes of the arch-shaped component. Thus, the two arch-shaped components are mounted on the right and left sides of the cap body, the left and right arch-shaped components are respectively located behind the ears of the cap wearer. The ear-loop straps of a mask on the left and right sides are placed in the grooved structures of the arch-shaped components of the cap respectively, instead of being directly placed on the ears, and the mask wraps the nose and mouth tightly

The present invention provides a cap with components for wearing a mask, which has the following beneficial effects:
1. By placing the ear-loop straps of the mask on the components with grooved structures of the cap behind the ears, the burden and discomfort caused to the ears by directly placing the ear-loop straps of the mask on the ears are eliminated.
2. The shapes and sizes of the arch-shaped components on the two sides of the cap are designed according to the principle of ergonomics. The left and right ear-loop straps of the mask can be routed around the upper and lower ends of the ears and placed in the grooved structures of the left and right components on the cap and will not slide out easily, and the ear-loop straps of the mask are pulled more tightly in suitable directions, and the mask wraps the nose and mouth more tightly. Thus, the cap improves the protective effect of the mask.
3. By fitting the snap buttons on the mounting base plates fixed on the cap into the snap holes in the inner vertical pieces of the arch-shaped components, the arch-shaped components with grooved structures used on the left and right sides of the cap can be easily mounted on the cap body and removed from the cap body easily, and the mounting and removal operations can be repeated. Thus, they can be used conveniently.

### BRIEF DESCRIPTION OF DRAWINGS

FIG. 1 is a right perspective view of an embodiment according to the present invention;

FIG. 2 is an exploded view of the structure of the components in the present invention;

FIG. 3 is a schematic diagram of the operation of the components in the present invention;

FIG. 4 is a right view of the cap according to the present invention when the cap is worn and used;

FIG. 5 shows an alternative embodiment of the partial appearance of some components in the present invention;

FIG. 6 shows another alternative embodiment of the partial appearance of some components in the present invention;

FIG. 7 shows an alternative embodiment of the appearance of some components in the present invention; and

FIG. 8 shows another alternative embodiment of the appearance of some components in the present invention.

### REFERENCE NUMERALS

20R—arch-shaped component on the right side
20R-B—alternative embodiment of the arch-shaped component on the right side
20R-C—alternative embodiment of the arch-shaped component on the right side
20V-R—alternative embodiment of the arch-shaped component on the right side
20C-R—alternative embodiment of the arch-shaped component on the right side
22R—inner vertical piece of the component on the right side
26R—snap holes in the upper section of the inner vertical piece of the component on the right side
26R-L—snap holes in the lower section of the inner vertical piece of the component on the right side
28R—hole in the middle section of the inner vertical piece of the component on the right side
32R—outer vertical piece of the component on the right side
32R-B—alternative embodiment of the outer vertical piece of the component on the right side
32R-C—alternative embodiment of the outer vertical piece of the component on the right side
34R—protrusion on the middle section of the outer vertical piece of the component on the right side
36R—holes in the middle section of the outer vertical piece of the component on the right side
38R—bottom connecting piece of the arch-shaped component on the right side
39R1—small notch at the upper end of the bottom connecting piece of the component on the right side
39R2—small notch at the lower end of the bottom connecting piece of the component on the right side
40R—mounting base plate on the right side
42R—snap buttons on the mounting base plate on the right side
44R—small holes in the mounting base plate on the right side
51—cap body
52R—sewing thread(s) on the right side
20L—arch-shaped component on the left side
20L-B—alternative embodiment of the arch-shaped component on the left side
20L-C—alternative embodiment of the arch-shaped component on the left side
20V-L—alternative embodiment of the arch-shaped component on the left side
20C-L—alternative embodiment of the arch-shaped component on the left side
22L—inner vertical piece of the component on the left side
26L—snap holes in the upper section of the inner vertical piece of the component on the left side
26L-R—snap holes in the lower section of the inner vertical piece of the component on the left side
28L—hole in the middle section of the inner vertical piece of the component on the left side
32L—outer vertical piece of the component on the left side
32L-B—alternative embodiment of the outer vertical piece of the component on the left side
32L-C—alternative embodiment of the outer vertical piece of the component on the left side
34L—protrusion on the middle section of the outer vertical piece of the component on the left side
36L—holes in the middle section of the outer vertical piece of the component on the left side
38L—bottom connecting piece of the arch-shaped component on the left side
39L1—small notch at the upper end of the bottom connecting piece of the component on the left side
39L2—small notch at the lower end of the bottom connecting piece of the component on the left side
40L—mounting base plate on the left side
42L—snap buttons on the mounting base plate on the left side
44L—small holes in the mounting base plate on the left side
52L—sewing thread(s) on the left side

### DETAILED DESCRIPTION OF THE INVENTION

In order to achieve the above-mentioned object of eliminating the pulling burden on the ears of a wearer caused by the ear-loop straps of a mask and improving the protective effect of the mask and the convenience in use, the present invention provides the following technical scheme: A cap with components for wearing a mask. The cap has features as below: The cap comprises a cap body (51), two plastic mounting base plates (40R, 40L) with snap buttons fixed on left and right sides of the cap body respectively, and two detachable arch-shaped components (20R, 20L) with grooved structures. A plurality of holes (44R) are formed in the strip-shaped plastic mounting base plate (40R) fixed on the right side of the cap for fixing the mounting base plate to the right side of the cap body by means of sewing, and a plurality of protruding plastic snap buttons (42R) are formed on an outwardly facing surface of the mounting base plate. The arch-shaped component on the right side (20R) has an integral grooved structure that is formed by an inner vertical piece (22R), an outer vertical piece (32R) and a bottom connecting piece (38R) together and is arch-shaped from a side view. A plurality of snap holes (26R) are formed in the inner vertical piece (22R) of the arch-shaped component on the right side, and the size and spacing of the snap holes correspond to the size and spacing of the snap buttons (42R) on the mounting base plate (40R) fixed on the right side of the cap body. By fitting the snap buttons on the mounting base plate (40R) fixed on the right side of the cap body into the plurality of snap holes (26R) in the inner vertical piece (22R) of the arch-shaped component on the right side, the arch-shaped component on the right side (20R) can be mounted on the mounting base plate on the right side (40R), so that the arch-shaped component on the right side is mounted on the right side of the cap body. Likewise, a plurality of holes (44L) are formed in the strip-shaped plastic mounting base plate (40L) fixed on the left side of the cap for fixing the mounting base plate to the left side of the cap body by means of sewing, and a plurality of protruding plastic snap buttons (42L) are formed on an outwardly facing surface of the mounting base plate. The arch-shaped component on the left side (20L) has an integral grooved structure that is formed by an inner vertical piece (22L), an outer vertical piece (32L) and a bottom connecting piece (38L) together and is arch-shaped from a side view. A plurality of snap holes (26L) are formed in the inner vertical piece (22L) of the arch-shaped component on the left side, and the size and spacing of the snap holes correspond to the size and spacing of the snap buttons (42L) on the mounting base plate (40L) fixed on the left side of the cap body. By fitting the snap buttons (42L) on the mounting base plate (40L) fixed on the left side of the cap body into the plurality of snap holes (26L) in the inner vertical piece (22L), the arch-shaped component on the left side (20L) can be mounted on the mounting base plate on the left side (40L), so that the arch-shaped component on the left side is mounted on the left side of the cap body.

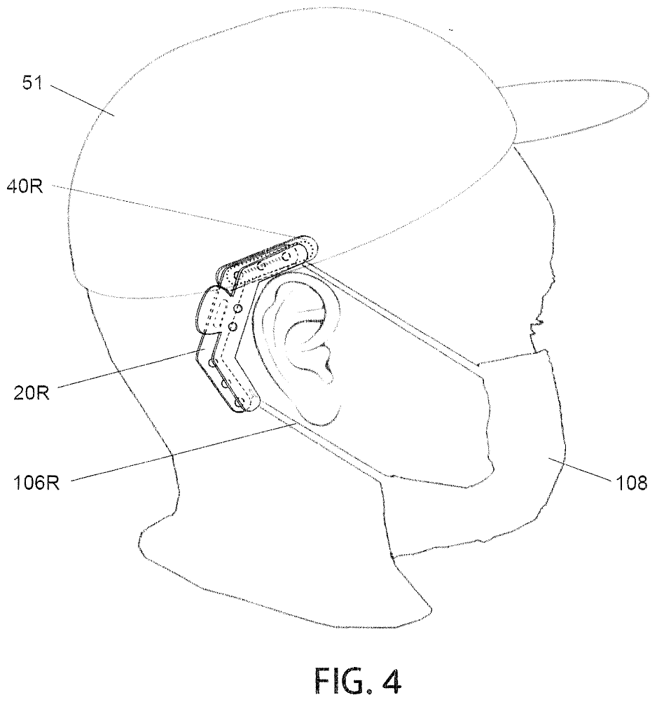

When the cap is worn on the head of a user, the arch-shaped components on the left and right sides of the cap are respectively located behind left and right ears and close to the ears, arch soffits of the two arch-shaped components face the ears, while openings of grooved structures at arch extrados sides of the two arch-shaped components face away from the ears, i.e., face rearward. Upper and lower sections of the ear-loop straps of the mask on the left and right sides are routed around upper and lower ends of the left and right ears and placed in the grooved structures of the arch-shaped components on the left and right sides of the cap respectively (as shown in FIG. 4), instead of directly being placed on the ears. The ear-loop straps of the mask are placed in the grooved structures of the components on the left and the right sides of the cap and will not slide out easily, and are pulled more tightly in suitable directions, so that the mask wraps the nose and mouth more tightly. In that way, the cap eliminates the burden and discomfort brought to the ears when the ear-loop straps of the mask are directly placed on the ears, therefore the protective effect of the mask is improved. By fitting the snap buttons on the mounting base plates fixed on the cap into the snap holes in the inner vertical pieces of the arch-shaped components, the arch-shaped components on the left and right sides of the cap can be easily mounted on the cap body and removed from the cap body, and the mounting and removal operations can be repeated. Thus, they can be used conveniently.

Preferably, protrusions (34R, 34L) are formed in the middle sections of the outer vertical pieces of the components with grooved structures used on the left and right sides of the cap body for gripping with fingers.

Preferably, holes (28R, 28L) are formed in the middle sections of the inner vertical pieces of the components with grooved structures used on the left and right sides of the cap body for tying a reinforcing strap at the back of the head when necessary. Preferably, holes (36R, 36L) are formed in the middle sections of the outer vertical pieces of the components with grooved structures used on the left and right sides of the cap body for mounting additional accessories to extend functions when necessary.

Preferably, the upper section and the lower section of the inner vertical piece of each component with a grooved structure used on the sides of the cap body are symmetric and similar in shape, and the plurality of snap holes (26R or 26L) in the upper section of the inner vertical piece and the plurality of snap holes (26R-L or 26L-R) in the lower section of the inner vertical piece are arranged symmetrically, so that the left component and the right component can be turned over and used interchangeably on the other side, which is to say, two identical components with grooved structures can be mounted and used on the left and right sides of the cap body in suitable positions respectively.

Preferably, the two ends of the bottom connecting pieces of the components with grooved structures used on the left and right sides of the cap body have small notches (as 39R1, 39R2), which are used for clamping the ear-loop straps of the mask more firmly and preventing the ear-loop straps of the mask from slipping out of the grooved structures of the devices.

The cap body may be commonly manufactured or obtained in the trade. The two strip-shaped mounting base plates and two detachable components with grooved structures fixed on the two sides of the cap body can be manufactured through injection molding processes, and the materials that can be used for the manufacturing may be a variety of plastic materials, silicone materials, or composite materials containing silicone and plastic materials, which have suitable hardness and flexibility.

### Operation of the Invention

The technical schemes and methods of use in the embodiments of the present invention will be described clearly and completely below with reference to the accompanying drawings in the embodiments. Apparently, the embodiments described herein are only some possible embodiments of the invention rather than all embodiments of the present invention. Those having ordinary skills in the art can obtain other embodiments on the basis of the embodiments described herein without expending any creative labor; however, all such embodiments shall be deemed as falling in the scope of protection of the present invention.

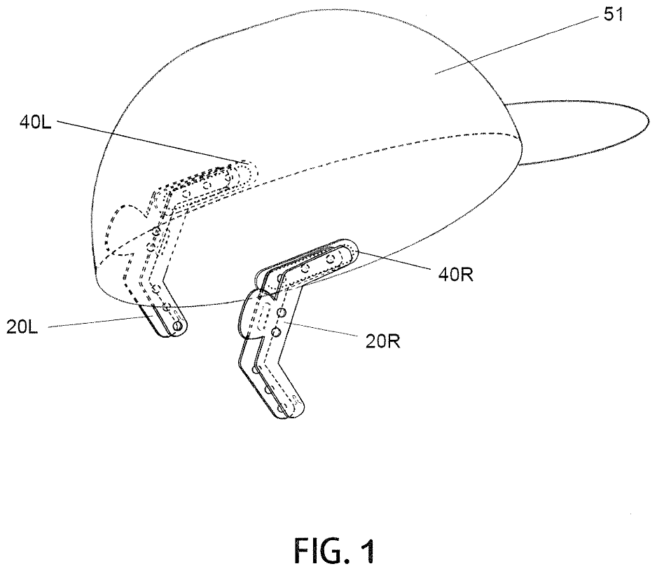

As shown in FIG. 1, the present invention relates to a cap with components for wearing a mask. The cap comprises a cap body (51), two plastic mounting base plates (40R, 40L) with snap buttons fixed on left and right sides of the cap body respectively, and two detachable arch-shaped components (20R, 20L) with grooved structures.

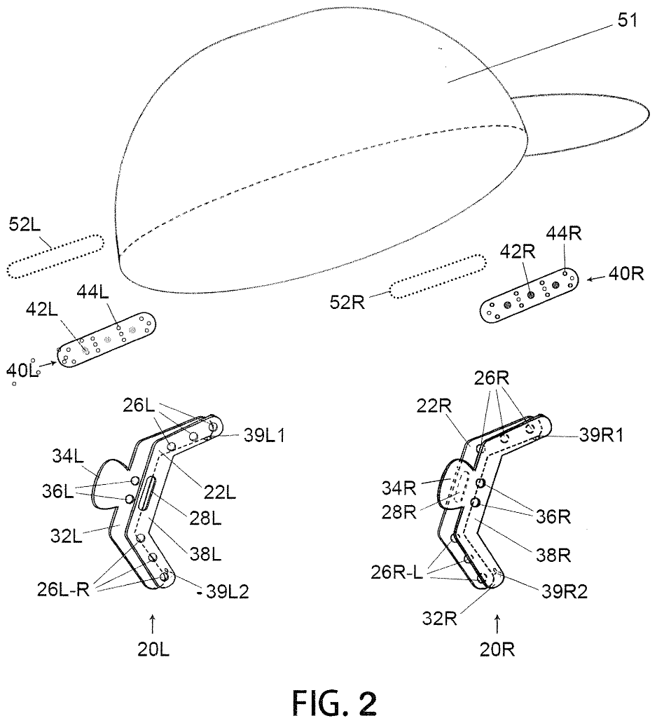

As shown in FIG. 2, the cap body (51) may be a cap with or without a visor which is clear without cover at left and right sides. It may be made of a variety of textile materials, may be in different models or for different uses, may be in different sizes, may include a top or may be a topless cap without a top, and may be with different types of back straps. The cap body may be commonly manufactured or obtained in the trade. A plurality of holes (44R) are formed in the strip-shaped plastic mounting base plate (40R) fixed on the right side of the cap for fixing the mounting base plate to the right side of the cap body by means of sewing, and a plurality of protruding plastic snap buttons (42R) are formed on an outwardly facing surface of the mounting base plate. The arch-shaped component on the right side (20R) has an integral grooved structure that is formed by an inner vertical piece (22R), an outer vertical piece (32R) and a bottom connecting piece (38R) and is arch-shaped from a side view. A plurality of snap holes (26R) are formed in the inner vertical piece (22R) of the arch-shaped component on the right side, and the size and spacing of the snap holes correspond to the size and spacing of the snap buttons (42R) on the mounting base plate (40R) fixed on the right side of the cap body. By fitting the snap buttons on the mounting base plate (40R) fixed on the right side of the cap body into the plurality of snap holes (26R) in the inner vertical piece (22R) of the arch-shaped component on the right side, the arch-shaped component on the right side (20R) can be mounted on the mounting base plate on the right side (40R), so that the arch-shaped component on the right side is mounted on the right side of the cap body. Likewise, a plurality of holes (44L) are formed in the strip-shaped plastic mounting base plate (40L) fixed on the left side of the cap for fixing the mounting base plate to the left side of the cap body by means of sewing, and a plurality of protruding plastic snap buttons (42L) are formed on an outwardly facing surface of the mounting base plate. The arch-shaped component on the left side (20L) has an integral grooved structure that is formed by an inner vertical piece (22L), an outer vertical piece (32L) and a bottom connecting piece (38L) and is arch-shaped from a side view. A plurality of snap holes (26L) are formed in the inner vertical piece (22L) of the arch-shaped component on the left side, and the size and spacing of the snap holes correspond to the size and spacing of the snap buttons (42L) on the mounting base plate (40L) fixed on the left side of the cap body. By fitting the snap buttons (42L) on the mounting base plate (40L) fixed on the left side of the cap body into the plurality of snap holes (26L) in the inner vertical piece (22L), the arch-shaped component on the left side (20L) can be mounted on the mounting base plate on the left side (40L), so that the arch-shaped component on the left side is mounted on the left side of the cap body.

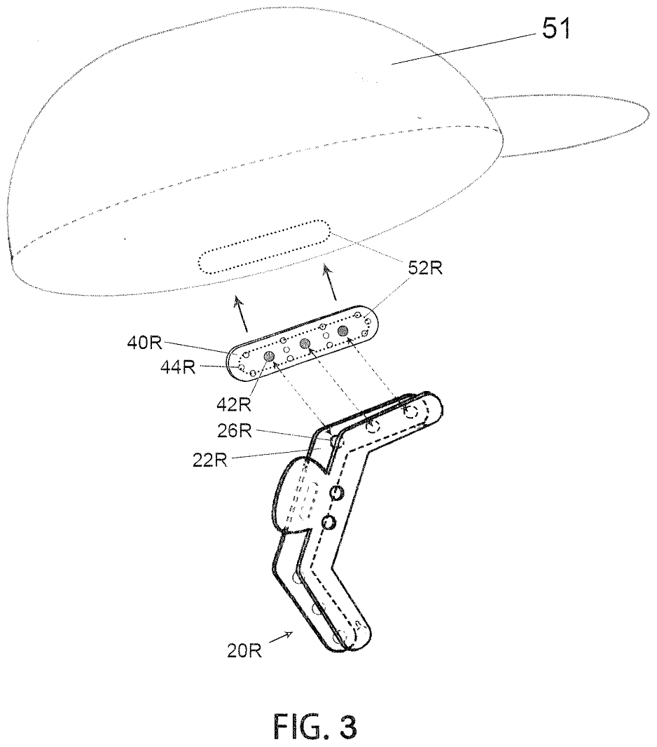

In an example of the component on the right side as shown in FIG. 3, sewing threads (52R) are inserted through the small holes (44R) in the mounting base plate on the right side (40R) and fix the mounting base plate on the right side (40R) to a suitable position on the right side of the cap body (51) by means of sewing. A plurality of protruding snap buttons (42R) are formed on an outwardly facing surface of the mounting base plate on the right side. A plurality of snap holes (26R) are formed in the inner vertical piece (22R) of the arch-shaped component on the right side (20R), and the size and spacing of the snap holes (26R) correspond to the size and spacing of the snap buttons (42R) on the mounting base plate (40R) fixed on the right side of the cap body. By fitting the snap buttons (42R) on the mounting base plate (40R) fixed on the right side of the cap body into the plurality of snap holes (26R) in the inner vertical piece (22R) of the arch-shaped component on the right side (20R), the arch-shaped component on the right side (20R) can be mounted on the mounting base plate on the right side (40R), so that the arch-shaped component on the right side is mounted on the right side of the cap body (51). The above operating method is also applicable to the component on the left side of the cap.

As shown in FIG. 4, when the cap is worn on the head of a user, the left and right arch-shaped components on the cap are respectively located behind left and right ears and close to the ears, arch soffits of the two arch-shaped components face the ears, while openings of grooved structures at arch extrados sides of the two arch-shaped components face away from the ears, i.e., face rearward. As shown in the figure, upper and lower sections of the ear-loop strap (106R) of the mask on the right side are routed around upper and lower ends of the right ear and placed in the grooved structure of the arch-shaped component on the right side of the cap, instead of directly being placed on the ear. The ear-loop strap of the mask on the left side is operated in the same way as the ear-loop strap of the mask on the right side. The ear-loop straps of the mask on the left and right sides are placed in the grooved structures of the left and right components of the cap and will not slide out easily, and are pulled more tightly in suitable directions, so that the mask (108) wraps the nose and mouth more tightly. In that way, the present invention eliminates the burden and discomfort brought to the ears when the ear-loop straps of the mask are directly placed on the ears, therefore the protective effect of the mask is improved. By fitting the snap buttons on the mounting base plates fixed on the cap into the snap holes in the inner vertical pieces of the arch-shaped components, the arch-shaped components with grooved structures on the left and right sides of the cap can be easily mounted on the cap and removed from the cap, and the mounting and removal operations can be repeated. Thus, they can be used conveniently.

The cap body may be commonly manufactured or obtained in the trade. The two strip-shaped mounting base plates and two detachable components with grooved structures fixed on the two sides of the cap body can be manufactured through injection molding processes, and the materials that can be used for the manufacturing may be a variety of plastic materials, silicone materials, or composite materials containing silicone and plastic materials, which are with suitable hardness and flexibility.

### Alternative Embodiments

The embodiments described herein are only some preferred embodiments of the invention rather than all possible embodiments of the present invention. Those skilled in the art should acknowledge that the embodiments described above are only intended to explain the present invention, but are not intended to limit the present invention. All variations, modifications, or equivalent replacements or improvements made to the embodiments described above without departing from the spirit and scope of the present invention shall be deemed as falling in the scope defined by the claims of the present invention.

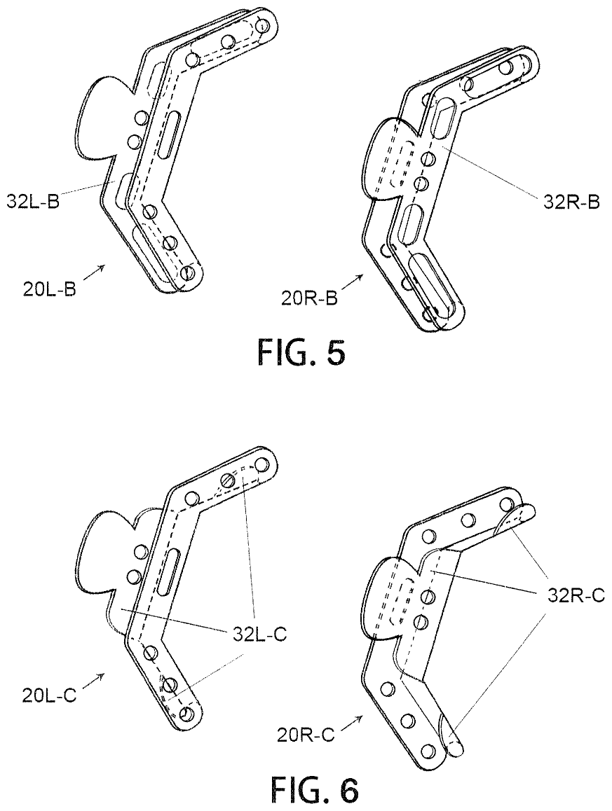

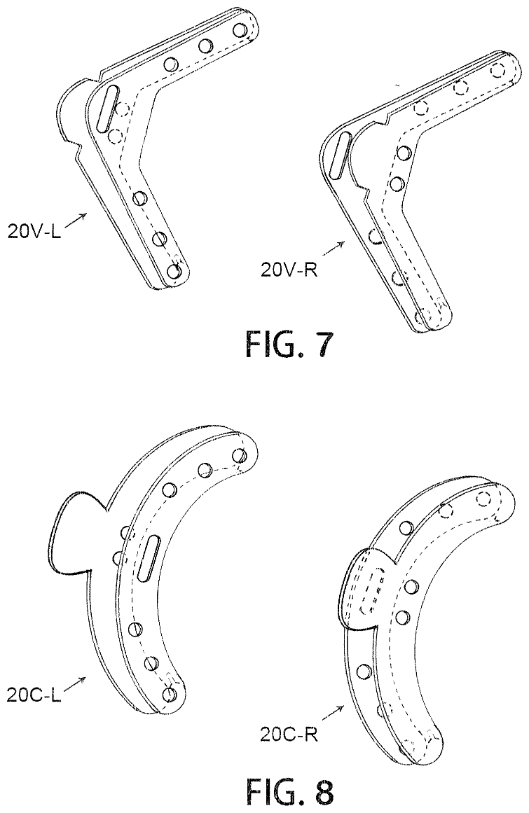

Some alternative embodiments in the scope defined by the claims of the present invention are described below:
1. In the present invention, the shapes of the sides of the two components with grooved structures used on the two sides of the cap body may alternatively be V-type triangular arches (20V-R, 20V-L as shown in FIG. 7), C-type round arches (20C-R, 20C-L as shown in FIG. 8), bow shapes, strip shapes, plate shapes, or other irregular shapes, besides the preferred bow-type three-centered arches.
2. The grooved structures of the two components used on the two sides of the cap body in the present invention may alternatively be formed only by an outer vertical piece and an inner vertical piece connected via the bottom edges of the two vertical pieces respectively, besides being formed by an outer vertical piece, an inner vertical piece and a bottom connecting piece respectively as described in the above embodiments. In that case, the cross section of the grooved structure is V-shaped.
3. In the present invention, the outer vertical piece and the inner vertical piece of each of the two components with grooved structures used on the two sides of the cap body may alternatively be in plate structures with hollow holes respectively, besides the preferred integral plate structure. For example, as shown in FIG. 5, the outer vertical piece on the right side may be the outer vertical piece with hollow holes 32R-B in an embodiment of the component on the right side 20R-B; the outer vertical piece on the left side may be the outer vertical piece with hollow holes 32L-B in an embodiment of the component on the left side 20L-B.
4. In the present invention, the outer vertical pieces of the two components with grooved structures used on the two sides of the cap body may alternatively be intermittent vertical pieces with notches. For example, as shown in FIG. 6, the outer vertical piece on the right side may be the intermittent outer vertical piece 32R-C in an embodiment of the component on the right side 20R-C; the outer vertical piece on the left side may be the intermittent outer vertical piece 32L-C in an embodiment of the component on the left side 20L-C.
5. In the present invention, the two mounting base plates and the two components with grooved structures fixed on the two sides of the cap body may be alternatively manufactured through other manufacturing processes such as 3D printing and machine engraving, besides the preferred injection molding processes. The materials used for the manufacturing may alternatively be biological materials, safe metals, or other suitable synthetic materials containing metals, besides preferred plastic materials, or silicone materials, or synthetic materials containing plastics and silicone.
6. Alternatively, the two arch-shaped components used at the right or left side of the cap may be directly attached on the left or right side of the cap, without using the mounting base plates.

1. A cap with components for wearing a mask, comprising a cap body, and two arch-shaped components arranged at the two sides of the cap body at positions corresponding to the ears, each of the arch-shaped components comprises an inner vertical piece and an outer vertical piece that are arch-shaped on two sides, and the inner vertical piece and the outer vertical piece are connected at the bottom to form a grooved structure; an upper section of the inner vertical piece is provided with snap holes; wherein ear-loop cords on two sides of the mask are respectively placed in the grooved structures of the arch-shaped components when the mask is worn.

2. The cap according to claim 1, wherein the two arch-shaped components are directly fixed to the cap body via the upper sections of the inner vertical pieces.

3. The cap according to claim 1, wherein a right mounting base plate and a left mounting base plate are fixedly arranged on the cap at positions corresponding to the ears, the right mounting bottom plate and the left mounting bottom plate are provided with snap buttons respectively, the snap buttons and the snap holes in the upper section of the inner vertical piece correspond to each other.

4. The cap according to claim 3, wherein the right mounting base plate and the left mounting base plate are further provided with holes for fixing.

5. The cap according to claim 1, wherein a middle section of the outer vertical piece is provided with protrusions, and a middle section of the inner vertical piece is provided with holes.

6. The cap according to claim 1, wherein the sides of the arch-shaped component are in a bow-type three-centered arch shape, V-type triangular arch shape or C-type round arch shape, bow shape, strip shape, sheet shape or other irregular shape.

7. The cap according to claim 1, wherein the inner vertical piece and the outer vertical piece are in an integral sheet structure or a sheet structure with hollow holes respectively.

8. The cap according to claim 1, wherein the outer vertical piece is a continuous vertical piece or an intermittent vertical piece with notches.

9. The cap according to claim 1, wherein a bottom connecting piece is provided between the inner vertical piece and the outer vertical piece.

10. The cap according to claim 9, wherein two ends of the bottom connecting piece are provided with notches.

11. The cap according to claim 1, wherein the upper section and the lower section of the inner vertical piece are symmetrical to each other and provided with snap holes respectively, and the snap holes in the upper section and the snap holes in the lower section of the inner vertical piece are symmetrical to each other in position.

12. The cap according to claim 1, wherein an included angle of an upper opening formed by the outer vertical piece and the inner vertical piece is between 0 degrees (parallel) and 80 degrees.

13. The cap according to claim 1, further comprising pressing pieces for ear shape correction, which are attached to the outer side of the outer vertical pieces respectively.

14. The cap according to claim 13, wherein the pressing piece for ear shape correction is provided with a plurality of raised buttons, and the middle section of the outer vertical piece is provided with a plurality of holes; the plurality of raised buttons and the plurality of holes correspond to each other.
